(19) United States
(12) Patent Application Publication
(10) Pub. No.: US 2026/0124531 A1
(43) Pub. Date: May 7, 2026

(54) PARKED CAR ENTERTAINMENT

(71) Applicant: Sony Interactive Entertainment Inc., Tokyo (JP)

(72) Inventors: Hideaki Iwaki, San Mateo, CA (US); Kusha Sridhar, San Mateo, CA (US); Xiaoyong Ye, San Mateo, CA (US); Zade Lobo, San Mateo, CA (US); Ayush Raina, San Mateo, CA (US)

(21) Appl. No.: 18/938,123

(22) Filed: Nov. 5, 2024

(51) Int. Cl. A63F 13/28; A63F 13/65

(52) U.S. Cl. CPC A63F 13/28; A63F 13/65

(57) ABSTRACT

A computer game being played in a parked vehicle can send signals to one or more vehicle actuators in synchronization with the game so that haptics can be generated by the vehicle's actuators as part of game play.

### FIELD

The present application relates generally to parked car entertainment and more specifically to integrating a vehicle's actuators in a computer game being played in a parked vehicle.

### BACKGROUND

With the increasing complexity of computer games or video games, the possibilities of game design that integrates components of other devices not heretofore used in computer games presents itself.

### SUMMARY

Accordingly, an apparatus includes at least one processor system configured to execute a computer game on the apparatus disposed in a vehicle. The processor system is configured to present the computer game on at least one display of the apparatus, and send signals from the apparatus to at least one processor system of the vehicle to actuate at least one component of the vehicle in synchronization with execution of the computer game.

In examples, the component can include one or more headlights of the vehicle, a vehicle horn, a brake actuator, a steering wheel, a shock absorber, a vehicle seat, a vehicle ventilation system, interior lighting of the vehicle.

In some embodiments the signals are provided to at least one application specific interface (API) executable by the processor system of the vehicle to control the at least one component in response to the signals.

In another aspect, a vehicle includes at least one processor system configured to receive signals from a device in the vehicle while the device is executing a computer game, and actuate at least one component of the vehicle in synchronization with execution of the computer game on the device.

In another aspect, a method includes playing a computer game on a device in a vehicle, and generating a signal to actuate at least one component of the vehicle responsive to play of the computer game.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 illustrates an example system in accordance with present principles;

FIG. 3 illustrates example overall logic in example flow chart format;

FIG. 4 illustrates example interlock logic in example flow chart format;

FIG. 5 illustrates an example user interface (UI) consistent with FIG. 4;

FIG. 6 illustrates example battery voltage logic in example flow chart format;

FIG. 7 illustrates an example UI consistent with FIG. 6; and

FIG. 8 illustrates example machine learning (ML) training logic in example flow chart format.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single-or multi-chip processor that can execute logic by means of various lines such as address lines, data lines, and control lines and registers and shift registers. A processor including a digital signal processor (DSP) may be an embodiment of circuitry. A processor system may include one or more processors.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

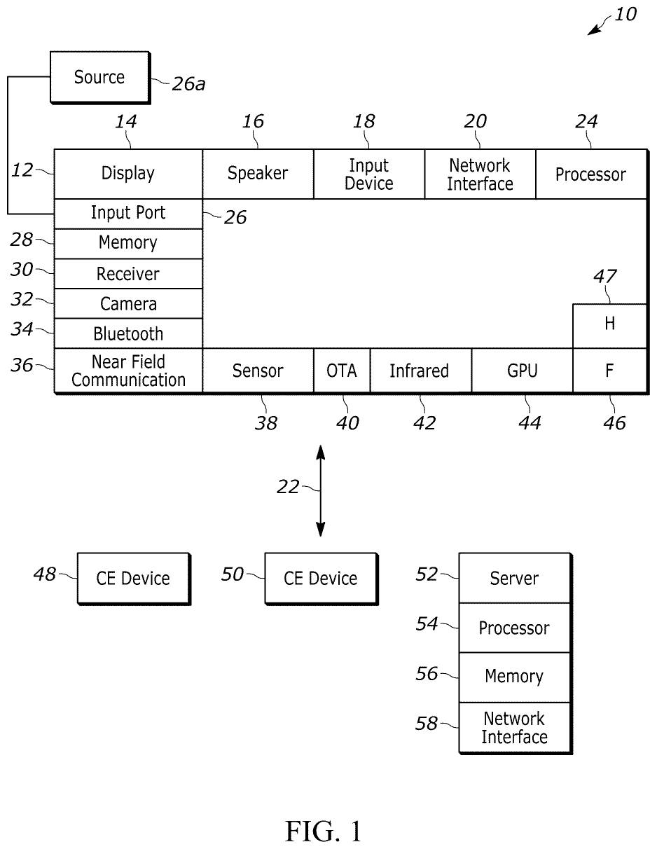

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative models such as large language models (LLM) such as generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that are configured and weighted to make inferences about an appropriate output.

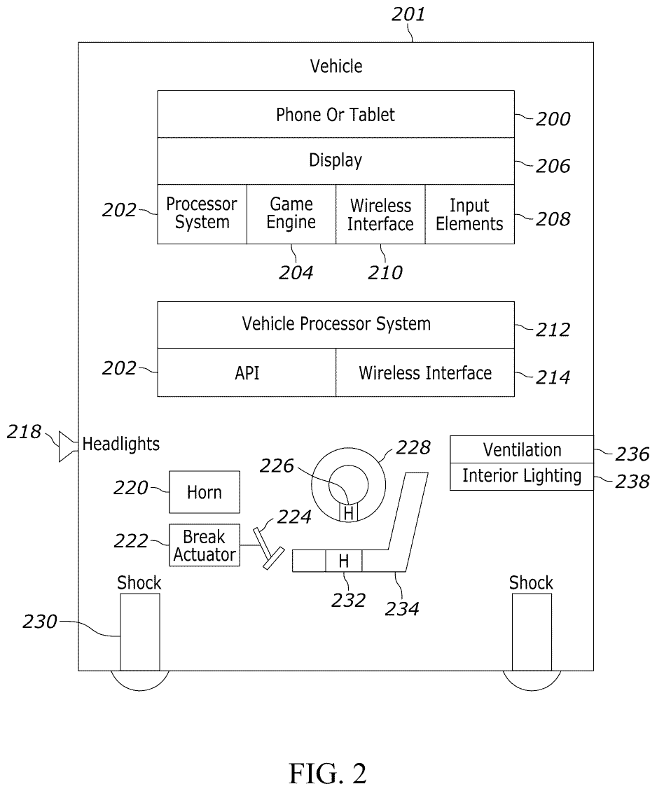

Refer now to FIG. 2. A device 200 such as a wireless phone or tablet computer can be disposed in a vehicle 201. The device 200 can include a processor system 202 to execute one or more game engines 204 for presentation of audio and video of the game on a display 206. Play of the game can be controlled by a person manipulating one or more input elements 208 of the device 200, such as hardware or software buttons, joysticks, and the like.

The device 200 includes one or more wireless interfaces 210 such as a Bluetooth interface or Wi-Fi interface to communicate with an in-vehicle processor system 212, which may include an engine control module (ECM). The vehicle processor system 212 can access a wireless interface 214 to communicate with the device 200. The vehicle processor system 212 can also execute an application specific interface (API) 216 downloaded from, e.g., the Internet to respond to commands from the device 200 to activate one or more components of the vehicle 201 to generate perceptible tactile, visual, and audio signals in synchrony with execution of the computer game being driven by the game engine 204. The API may include a machine learning (ML) model such as a generative model such as an LLM trained in accordance with description herein to determine what game engine inputs should enable which vehicle components. Or, the API may be a rules-based module that responds to direct commands from the game engine to actuate specific vehicle components in specific ways.

FIG. 2 illustrates various vehicle components that may be activated by the API 216 in response to commands from the device 200, e.g., from the game engine 204 being executed thereon. Headlights 218 may be activated to flash, e.g., synchronized to game audio/shooting. A vehicle horn 220 may be activated to honk in synchrony with a game event, and a brake actuator 222 may be activated to pump a brake pedal 224 in synchrony with a game event. A haptic generator 226 on a steering wheel 228 may be activate to vibrate or turn the steering wheel or heat the steering wheel in synchrony with a game event. One or more shock absorbers 230 may be activate to pump the vehicle up and down or other shake or move the vehicle in synchrony with a game event.

Further, one or more haptic generators 232 on a vehicle seat 234 may be activated to move or heat the seat 234 in synchrony with a game event. The seat haptic generator 232 may be established by, e.g., a motor that moves the seat.

A vehicle ventilation system 236 may be activated to heat or cool the interior of the vehicle in synchrony with a game event. Interior lighting 238 may be activated to blink or flash in synchrony with a game event.

The flow charts herein illustrate logic that may be executed by any one or more of the processor systems described herein.

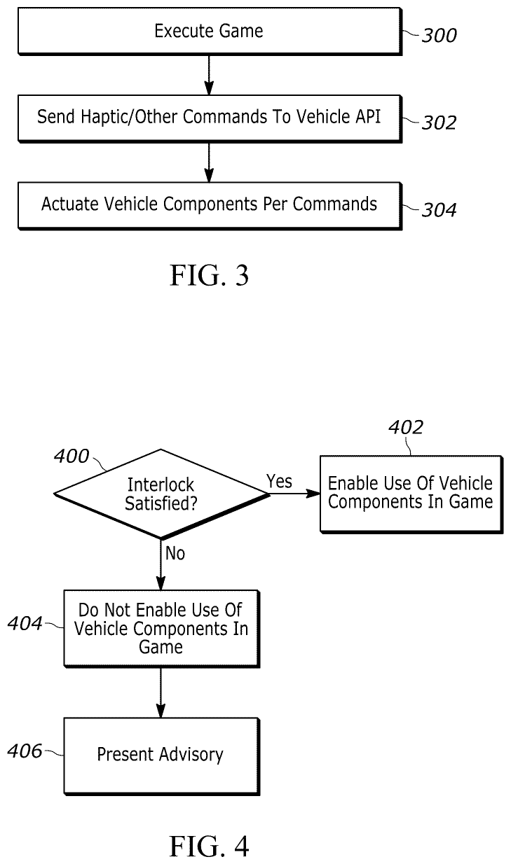

Turn now to FIG. 3. Commencing at state 300 the computer game is executed on the device 200 shown in FIG. 2. Signals indicating current or shortly upcoming game events are sent from the device 200 to the API 216 at state 302 to actuate one or more vehicle components in response at state 304.

In non-limiting actions, signals from the game engine may indicate that shots were fired. This may cause the API to vibrate the steering wheel or brake pedal. As another example, signals from the game engine may indicate that the player character has entered a hot area. This may cause the API to activate the ventilation system to heat the vehicle. As another example, signals from the game engine may indicate an earthquake. This may cause the API to bounce the vehicle by activating and deactivating the shock absorbers or vibrate the seat. Or, signals from the game engine may indicate lightning in the game. This may cause the API to flash the headlights and/or the interior lighting on and off. Signals from the game engine may indicate a flock of geese in the game. This may cause the API to activate the horn.

Note that in some embodiments, to enable use of vehicle components as computer game adjuncts, the player may be prompted to indicate consent by manipulating a window up/down switch or make an “OK” gesture that is imaged by a camera or by other means such as through the UI described below.

FIG. 4 illustrates logic that may be executed to ensure an interlock is satisfied to enable use of vehicle components for computer game play. Commencing at state 400, it is determined whether an interlock is satisfied. An example interlock is that the car shift lever is in park. Another example interlock is that the car ignition is off. If the interlock is satisfied, use of one or more vehicle components for computer game purposes is enabled at state 402. If the interlock is not satisfied, use of vehicle components for computer game purposes is disabled (or not enabled) at state 404, and an advisory may be presented, e.g., on the display 206 shown in FIG. 2.

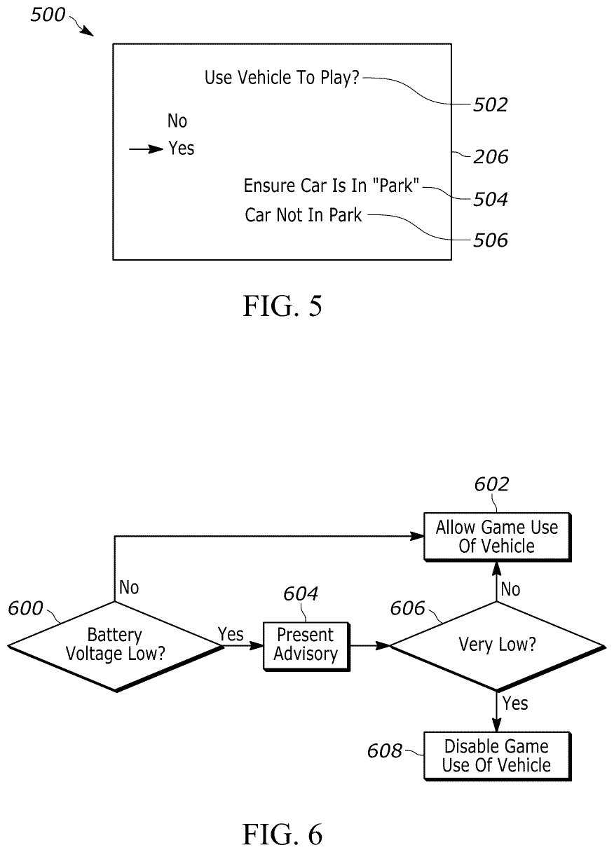

FIG. 5 illustrates a UI 500 that can present such an advisory on any display herein such as the display 206 shown in FIG. 2. A prompt 502 may be presented to allow the user to select whether to use vehicle components as adjuncts to computer game play, i.e., whether to enable the logic of FIG. 3. If the user selects “yes” a second prompt 504 may be presented to the user to ensure the interlock is met. If the interlock is not met a third prompt 506 may so indicate.

Note that additional interlocks may be provided. For example, the API 216 can use geo fencing to ensure that no vehicle components are actuated by game play signals if the person in the driver's seat, even though the vehicle may be parked, holds the device 200 during game play. This may be done by comparing the relative location of the device 200 in the vehicle as indicated by the GPS location of the device 200 and GPS location of the vehicle with the known location of the driver's seat relative to the vehicle GPS location.

Another example interlock may be based on the location of the vehicle or example, if the vehicle is parked near an airport, actuation of the horn and/or headlights in response to game signals may be disabled.

FIG. 6 illustrates further example logic. Commencing at state 600, if it is determined that the voltage of the vehicle's battery is acceptable, use of vehicle components during game play is enabled at state 602. However, if it is determined that the voltage of the vehicle's battery reaches a first low threshold voltage an advisory may be presented at state 604 on, e.g., the device 200 shown in FIG. 2. If it is determined that the voltage of the vehicle's battery is below the first threshold voltage but above a second, lower threshold voltage at state 606, use of vehicle components may still be enabled for game play at state 602. In the non-limiting example of FIG. 6, only if the battery voltage drops below the second threshold is use of vehicle components for game play disabled at state 608. Note that the second voltage threshold may be eliminated and use of vehicle components for game play disabled responsive to the first voltage threshold being violated.

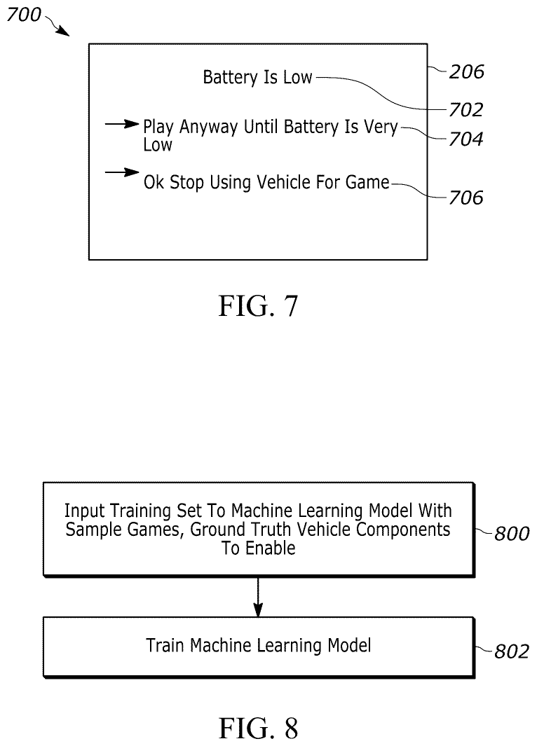

FIG. 7 illustrates a UI 700 that can present an advisory 702 that vehicle battery voltage is low on any display herein such as the display 206 shown in FIG. 2. A first selector 704 may be selectable to enable use of vehicle components as adjuncts to game play until voltage becomes very low. A second selector 706 may be selectable to disable use of the vehicle components as game play adjuncts.

FIG. 8 illustrates training logic that may be applied to a ML model implementing the API 216 in FIG. 2. A set of training data is input to the ML model at state 800 to train the model at state 802. The training set may include samples of computer games along with respective ground truth indications of which vehicle components should be enabled and how during game play in synchrony with the game execution, such as any of the example correspondences noted above.

Note that present principles can be applied to parked car multiplayer location based entertainment, in which, for example, a parking lot can be converted to a parked car battle arena in which a parking lot is converted into a virtual/MR battleground and every parked car into a powerful gaming pod which play against occupants of other parked cars nearby (as indicated by, e.g., GPS) and showing the same game, creating a new category of immersive, location-based multiplayer experiences,

While the particular embodiments are herein shown and described in detail, it is to be understood that the subject matter which is encompassed by the present invention is limited only by the claims.

What is claimed is:

1. An apparatus comprising:
at least one processor system configured to:
execute a computer game on the apparatus disposed in a vehicle;
present the computer game on at least one display of the apparatus; and
send signals from the apparatus to at least one processor system of the vehicle to actuate at least one component of the vehicle in synchronization with execution of the computer game.

2. The apparatus of claim 1, wherein the component comprises headlights of the vehicle.

3. The apparatus of claim 1, wherein the component comprises a vehicle horn.

4. The apparatus of claim 1, wherein the component comprises a brake actuator.

5. The apparatus of claim 1, wherein the component comprises a steering wheel.

6. The apparatus of claim 1, wherein the component comprises a shock absorber.

7. The apparatus of claim 1, wherein the component comprises a vehicle seat.

8. The apparatus of claim 1, wherein the component comprises a vehicle ventilation system.

9. The apparatus of claim 1, wherein the component comprises interior lighting of the vehicle.

10. The apparatus of claim 1, wherein the signals are provided to at least one application specific interface (API) executable by the processor system of the vehicle to control the at least one component in response to the signals.

11. The apparatus of claim 10, further comprising the API and processor system of the vehicle.

12. A vehicle comprising:
at least one processor system configured to:
receive signals from a device in the vehicle while the device is executing a computer game; and
actuate at least one component of the vehicle in synchronization with execution of the computer game on the device.

13. The vehicle of claim 12, wherein the processor system is configured to:
responsive to an interlock being satisfied, enable actuation of at least one component of the vehicle in synchronization with execution of the computer game on the device; and
responsive to the interlock not being satisfied, not enable actuation of at least one component of the vehicle in synchronization with execution of the computer game on the device.

14. The vehicle of claim 13, wherein the interlock comprises a vehicle shift lever being in park.

15. The vehicle of claim 13, wherein the interlock comprises a vehicle ignition being off.

16. The vehicle of claim 13, wherein the interlock is based on a location of the vehicle.

17. The vehicle of claim 13, wherein the interlock is based on a relative location of the device within the vehicle.

18. The vehicle of claim 12, wherein the processor system is configured to:
disable actuation of the at least one component of the vehicle in synchronization with execution of the computer game on the device responsive to a voltage of a vehicle battery having a first value.

19. A method, comprising:
playing a computer game on a device in a vehicle; and
generating a signal to actuate at least one component of the vehicle responsive to play of the computer game.

20. The method of claim 19, comprising:
actuating the at least one component of the vehicle responsive to play of the computer game.
